(19) United States
(12) Patent Application Publication
(10) Pub. No.: US 2008/0012338 A1
(43) Pub. Date: Jan. 17, 2008

(54) Coupling arrangement for an electrical conduit and method of use thereof

(76) Inventor: John Wiese, Florissant, MO (US)

Correspondence Address: GREENSFELDER HEMKER & GALE PC, SUITE 2000, 10 SOUTH BROADWAY, ST LOUIS, MO, 63102, US

(21) Appl. No.: 11/487,775

(22) Filed: Jul. 17, 2006

(51) Int. Cl. F16L 21/00

(52) U.S. Cl. 285/417

(57) ABSTRACT

A coupling arrangement for installing an electrical conduit encased in concrete is disclosed. The coupling arrangement includes an elongated, hollow nonmetallic coupling member defining a conduit in communication with a proximal opening and a distal opening. The coupling member further includes an inner annular shoulder defined around the inner circumference of the conduit which divides the conduit into a shorter conduit and a longer conduit. The inner annular shoulder may be adapted to abut a connection member when operatively connecting the coupling member to an electrical box after the concrete has been allowed to cure. Prior to connection to the electrical box, the coupling member may be cut flush with the concrete surface and the new distal opening closed off with a plug until the installer is ready to engage the connection member.

### FIELD

The present document relates to a coupling arrangement, and more particularly to a coupling arrangement for use in establishing an electrical conduit and method of use thereof.

### BACKGROUND

Typically, an electrical conduit may be established in residential and commercial buildings by installing non-metallic tubing, such as Electrical Non-Metallic Tubing (“ENT”) or PVC tubing, adapted for encasing wire used to supply electrical or data networks. In some instances, it may be desirable to encase the electrical conduit in poured concrete, or embedded in a concrete slab on grade where the non-metallic tubing is secured to chairs or rebars prior to being encased or embedded in concrete in order to prevent floating of the non-metallic tubing and hold it in position during the pouring of fluid concrete.

In one implementation, the installer may use a “stub up” method of installing the non-metallic tubing by pouring the fluid concrete over most of the non-metallic tubing while leaving one end portion of the non-metallic tubing exposed above the fluid concrete as illustrated in FIG. 1A. The stub up method of installing an non-metallic tubing 4 requires that the end portion of the non-metallic tubing remain exposed above the concrete over time as the concrete cures so that a prior art coupling device may be later engaged to the end portion of the non-metallic tubing 4.

In general, the prior art coupling device 2 connects the non-metallic tubing 4 to other non-metallic tubing 4 such that wires disposed inside the non-metallic tubing 4 may be operatively engaged to a terminal end point (not shown) such as an electrical box or other electrical or data network. As shown in FIG. 1A, the prior art coupling device 2 may have a compact hollow body 3 defining a conduit 7 in communication with opposing openings 5, 6 adapted to engage two end portions of non-metallic tubing 4 together as noted above after the concrete has been allowed to cure. The prior art coupling device 2 may further include an inner annular shoulder 8 defined along the inner circumference of conduit 7 at a point equidistant between the opposing openings 5, 6. Prior art coupling device 2 may then be engaged to an exposed end portion of non-metallic tubing 4 by inserting the non-metallic tubing 4 into one of the opposed openings of the prior art coupling device 2 until the non-metallic tubing 4 abuts the inner annular shoulder 8.

The other side of the prior art coupling device 2 may then be engaged to another non-metallic tubing 4 by inserting that other non-metallic tubing 4 into the other opposed opening 5 or 6 until the other non-metallic tubing 4 abuts the other side of the inner annular shoulder 8. Glue or other suitable means of attaching the prior art coupling device 2 to the non-metallic tubing 4 may be used to form a secure bond. The other non-metallic tubing 4 may then be attached to an electrical box or another non-metallic tubing 4 so that wires disposed inside the non-metallic tubing 4 can be operatively connected to the electrical box.

However, the exposed end portion of the non-metallic tubing 4 may remain exposed above the concrete surface for some time after the concrete has cured before being operatively coupled to the electrical box since other construction work must usually be completed before the installer can engage the exposed end of the non-metallic tubing 4 to the prior art coupling device 2.

Unfortunately in the interim, as illustrated in FIG. 1b, the exposed end portion of the non-metallic tubing 4 above the concrete surface can become damaged over time due to construction personnel inadvertently contacting or otherwise running over the exposed non-metallic tubing 4 with other equipment such that the exposed end portion of the non-metallic tubing 4 becomes broken, twisted and/or unusable as a connection point for engagement of the prior art coupling device 2.

Further, the exposed end portion of the non-metallic tubing 4 may become filled with collected debris if the opening remains exposed over time which can interfere with pulling of the wires through the non-metallic tubing 4 during installation. As such, the installer may have to first dig out and remove the debris along the length of the non-metallic tubing 4 and then reinstall the non-metallic tubing 4 in order to provide a suitable connection point for engagement with the prior art coupling device 2 which can be time consuming and expensive procedure.

Accordingly, a novel coupling arrangement is needed that overcomes the drawbacks in the prior art.

### SUMMARY

In an embodiment, a coupling arrangement may include a non-metallic tubing defining a first conduit, the non-metallic tubing being encased in concrete that defines a concrete surface, a coupling member defining a second conduit in communication with a proximal opening and a distal opening, the proximal opening being in communication with the first conduit of the non-metallic tubing, the second conduit defining an inner annular shoulder, the inner annular shoulder dividing the second conduit into a shorter conduit and a longer conduit, and a connection member defining a third conduit in communication with the coupling member, the connection member being engaged to the coupling member such that the one end of the connection member abuts the inner annular shoulder of the coupling member.

In another embodiment, a method of establishing an electrical conduit may include:
a) establishing an electrical raceway defining a first conduit;
b) engaging a coupling member with the electrical raceway with the coupling member defining a second conduit in communication with a proximal opening and a distal opening, the second conduit defining an inner annular shoulder, and the inner annular shoulder dividing the second conduit into a shorter conduit and a longer conduit;
c) pouring a fluid concrete over the electrical raceway and the coupling member with the fluid concrete defining a concrete surface, the coupling member being engaged to the electrical raceway such that the distal end of the coupling opening extends above the concrete surface;
d) allowing the fluid concrete to cure, and
e) removing a portion of the coupling member extending above the concrete surface such that the proximal opening of the coupling member is flush with the concrete surface.

Implementation of the above embodiments may include one or more of the following features:

The longer conduit is greater in length than the shorter conduit.

The coupling arrangement further comprising a plug with the plug adapted to be engaged to the distal opening of the coupling member.

The plug includes an umbrella with a taper stem extending axially from the umbrella.

The distal opening is substantially flush with the concrete surface.

The coupling member extends above the concrete surface.

The method further including plugging the second conduit of the coupling member with a plug.

The method further including removing the plug from the coupling member.

The method further including inserting a connection member into the coupling member with the connection member defining a third conduit in communication with an open end, the open end of the connection member being engaged to the annular shoulder when inserting the connection member into the coupling member.

Additional objectives, advantages and novel features will be set forth in the description which follows or will become apparent to those skilled in the art upon examination of the drawings and detailed description which follows.

### BRIEF DESCRIPTION OF THE DRAWINGS

FIG. 1A is a simplified side view of a prior art coupling arrangement;

FIG. 1B is a simplified side view of the prior art coupling arrangement illustrating the damage that occurs when the coupling arrangement extends above a concrete surface;

FIG. 2 is a perspective view of a coupling member;

FIG. 3 is a cross-sectional view of the coupling member taken along line 3-3 of FIG. 2;

FIG. 4 is a perspective view of a plug used with the coupling member; and

FIGS. 5A-5D illustrate the sequence of installing the coupling arrangement.

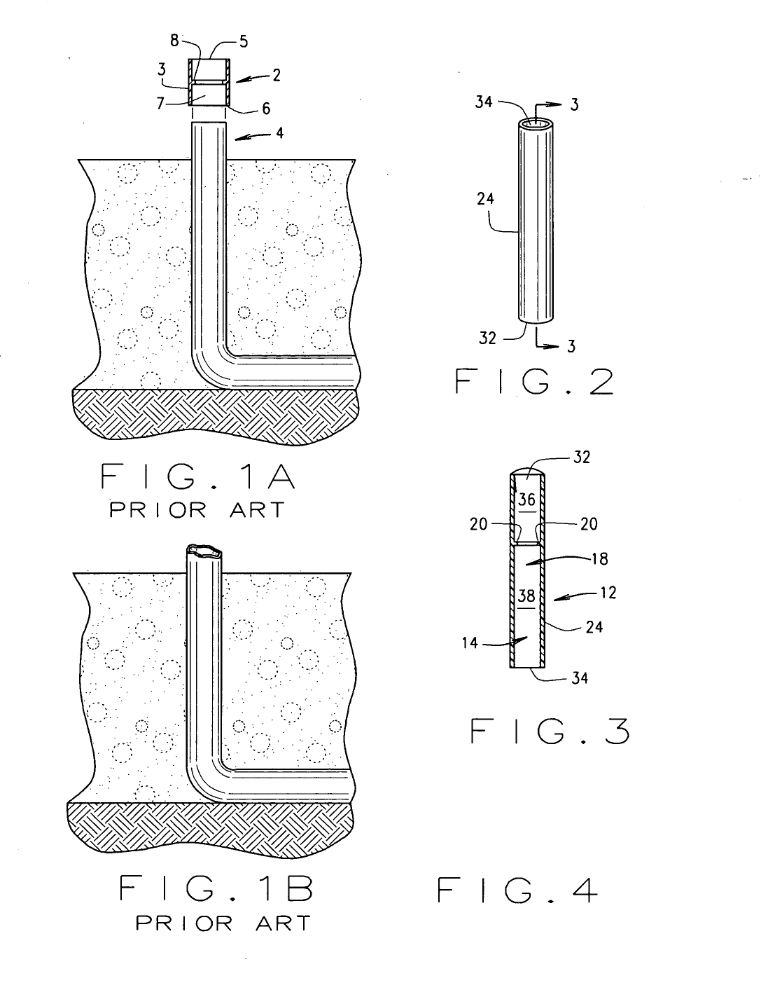

Corresponding reference characters indicate corresponding elements among the view of the drawings.

### DETAILED DESCRIPTION

Referring to the drawings, a coupling arrangement for establishing an electrical conduit is illustrated and generally indicated as 10 in FIGS. 2-5.

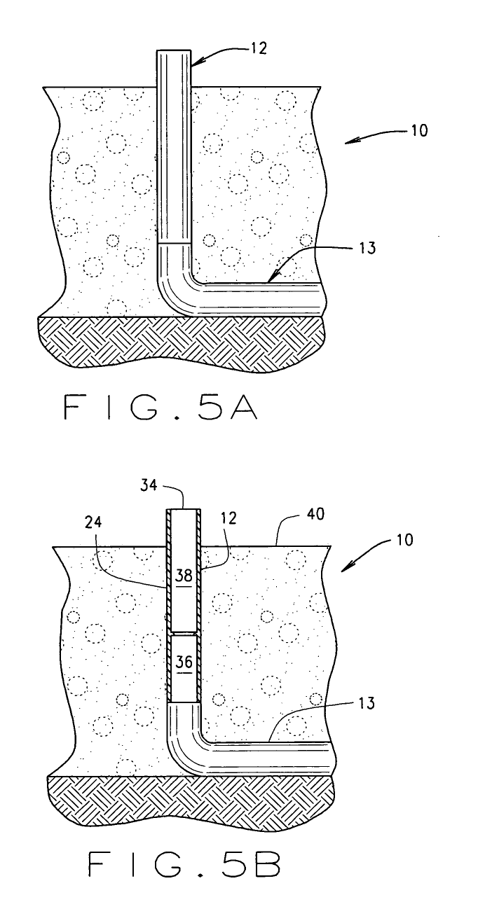

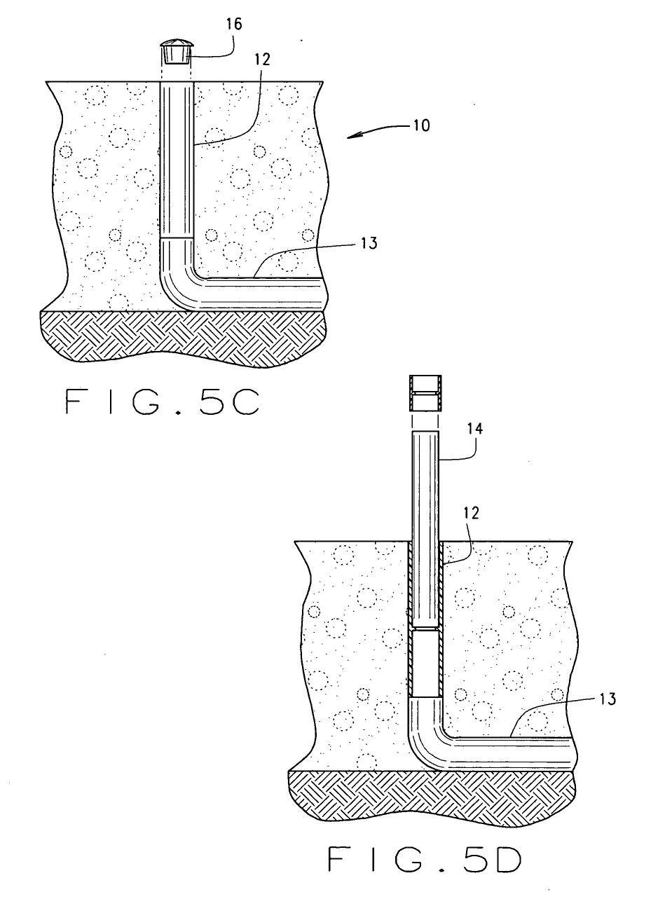

As shown in FIG. 5A, coupling arrangement 10 may include a non-metallic tubing 13, for example ENT or PVC, secured to either chairs (not shown) or rebars (not shown) such that non-metallic tubing 13 will be prevented from floating and will be held in position during the pouring of fluid concrete over the non-metallic tubing 13 as shall be discussed in greater detail below.

Referring to FIGS. 2 and 3, coupling arrangement 10 may include a hollow, elongated coupling member 12 having a tubular body 24 defining a conduit 14 in communication with a proximal opening 32 and a distal opening 34. In one embodiment, the coupling member 12 may be made from any type of rigid non-metallic tubing, such as PVC or like material, which is suitable for use in establishing an electrical conduit for wires used in electrical or data networks. Coupling member 12 may further include an inner annular shoulder 20 defined along the inner surface of tubular body 24 which divides conduit 18 into a shorter conduit 36 that communicates with proximal opening 32 and a longer conduit 38 that communicates with distal opening 34.

Referring to FIGS. 3 and 4, coupling member 12 may be adapted to engage a plug 16 for sealing off the distal opening 34 such that debris may be prevented from entering conduit 18 during installation of the coupling arrangement 10. Plug 16 may include an umbrella 44 having a tapered stem 46 extending axially from the umbrella 44. In one embodiment, the tapered stem 26 may be sized and shaped to engage distal opening 34 such that a seal is established that prevents debris from entering conduit 18.

Referring to FIGS. 5A-5D, the method of installing and assembling the coupling arrangement 10 will be discussed. As shown in FIG. 5A, non-metallic tubing 13 may be installed from an electrical source or data network along a layer of rebar or other suitable surface prior to pouring fluid concrete over tubing 13. In one embodiment, the non-metallic tubing 13 may be secured to one or more chairs or layer of rebar in order to prevent the non-metallic tubing 13 from floating when the fluid concrete is poured. The proximal opening 32 of coupling member 12 may then be secured to the non-metallic tubing 13 such that the shorter conduit 36 of coupling member communicates directly with the non-metallic tubing 13.

Referring to FIG. 5B, fluid concrete may then be poured over the non-metallic tubing 13 and coupling member 12 such that a portion of the coupling member 12 remains exposed a certain distance above the concrete surface 40 defined by the cured concrete. In one embodiment, the portion of the coupling member 12 having the distal opening 34 should be exposed above the concrete surface 40, while the proximal opening 32 is encased in concrete and engaged to the non-metallic tubing 13. In addition, this orientation of the coupling member 12 places the shorter conduit 36 in direct communication with the non-metallic tubing 13 while the longer conduit 38 is in direct communication with atmosphere. In one aspect, the coupling member 12 may be engaged to non-metallic tubing 13 using glue, epoxy, or other suitable means of attachment.

After the fluid concrete is allowed to cure, the installer cuts and removes enough of the coupling member 12 above the concrete surface 40 such that distal opening 34 is now substantially flush with the concrete surface 40 as illustrated in FIG. 5C. As further shown, the installer may then insert a plug 16 and close off distal opening 34 such that debris is prevented from entering the coupling member 12.

Referring to FIG. 5D, the user may then disengage the plug 16 and engage a connection member 14 to coupling member 12 by inserting the connection member 14 through distal opening 34 and into the longer conduit 38 until connection member 14 abuts the annular shoulder 20. The installer may then engage further connection members 14 to one another until the coupling arrangement 10 reaches a terminal point, such as, but not limited to an electrical box or data terminal.

Finally, the installer may feed wires (not shown) through the coupling arrangement 10 until such wires reach the terminal point for operative engagement with an electrical and/or data network, for providing electrical or data transmission connections.

As noted above the method of installing the coupling arrangement 10 does not require that the coupling member 12 be left exposed after the fluid concrete has cured in order to avoid having the coupling member 12 from being inadvertently damaged prior to completing assembly of the coupling member 12. In addition, the coupling member 12 is configured such that the shorter conduit 36 has a shorter length than the longer conduit 38.

1. A coupling arrangement comprising:
a non-metallic tubing defining a first conduit, said non-metallic tubing being encased in concrete that defines a concrete surface,
a coupling member defining a second conduit in communication with a proximal opening and a distal opening, said proximal opening in communication with said first conduit of said non-metallic tubing, said second conduit defining an inner annular shoulder, said inner annular shoulder dividing said second conduit into a shorter conduit and a longer conduit, and
a connection member defining a third conduit in communication with said coupling member, said connection member being engaged to said coupling member such that said one end of said connection member abuts said inner annular shoulder of said coupling member.

2. The coupling arrangement according to claim 1, wherein said longer conduit is greater in length than said shorter conduit.

3. The coupling arrangement according to claim 1, further comprising a plug, said plug adapted to be engaged to said distal opening of said coupling member.

4. The coupling arrangement according to claim 3, wherein said plug includes an umbrella with a taper stem extending axially from said umbrella.

5. The coupling arrangement according to claim 1, wherein said distal opening is substantially flush with said concrete surface.

6. The coupling arrangement according to claim 1, wherein said coupling member extends above said concrete surface.

7. A method of establishing an electrical conduit comprising:
a) establishing an electrical raceway defining a first conduit;
b) engaging a coupling member with said electrical raceway, said coupling member defining a second conduit in communication with a proximal opening and a distal opening, said second conduit defining an inner annular shoulder, said inner annular shoulder dividing said second conduit into a shorter conduit and a longer conduit,
c) pouring a fluid concrete over said electrical raceway and said coupling member, said fluid concrete defining a surface, said coupling member being engaged to said electrical raceway such that said distal end of said coupling opening extends above said concrete surface,
d) allowing the fluid concrete to cure, and
e) removing a portion of said coupling member extending above said concrete surface, such that said proximal opening of said coupling member is flush with said cement surface.

8. The method according to claim 7, further including:
f) plugging second conduit of said coupling member with a plug.

9. The method according to claim 7, further including:
g) removing said plug from said coupling member.

10. The method according to claim 9, further including:
h) inserting a connection member into said coupling member, said connection member defining a third conduit in communication with an open end, said open end of said connection member being engaged to said annular shoulder when inserting said connection member into said coupling member.
